(19) United States
(12) Patent Application Publication
(10) Pub. No.: US 2020/0384492 A1
(43) Pub. Date: Dec. 10, 2020

(54) IMITATION PAINT SYSTEM AND IMITATION PAINT METHOD

(71) Applicant: KAWASAKI JUKOGYO KABUSHIKI KAISHA, Kobe-shi, Hyogo (JP)

(72) Inventors: Takuya ICHISE, Kobe-shi (JP); Tomoyuki NAGAO, Kobe-shi (JP); Hideki ISODA, Kakogawa-shi (JP)

(73) Assignee: KAWASAKI JUKOGYO KABUSHIKI KAISHA, Kobe-shi, Hyogo (JP)

(21) Appl. No.: 16/767,364

(22) PCT Filed: Nov. 26, 2018
(86) PCT No.: PCT/JP2018/043390

§ 371 Date: May 27, 2020

(30) Foreign Application Priority Data
Nov. 27, 2017 (JP) 2017-227211

(51) Int. Cl. B05B 13/04; B05D 1/02; B05B 15/70; G09F 19/12

(52) U.S. Cl. CPC B05B 13/04; G09F 19/12; B05B 15/70; B05D 1/02

(57) ABSTRACT

An imitation paint system includes a workpiece, a paint machine main body having a nozzle configured to discharge liquid to the workpiece, and a water feeding device configured to supply water as the liquid to the paint machine main body. At least a part or all of a surface part of the workpiece is made of material containing a color-changing substance. The color-changing substance presents a first color in a dry state and presents a second color different from the first color in a water-wet state.

### TECHNICAL FIELD

The present disclosure relates to an imitation paint system and an imitation paint method which are usable for a demonstration of a painting process.

### BACKGROUND ART

There is a work for painting a workpiece by spraying paint onto the workpiece with a painting device, such as a paint gun. For example, Patent Document 1 discloses a technology in which a painting device is attached to a wrist of a manipulator to paint on a body of an automobile. Such a paint work is generally performed inside a factory.

### REFERENCE DOCUMENT OF CONVENTIONAL ART

### Patent Document

[Patent Document 1] JP2014-061589A

### DESCRIPTION OF THE DISCLOSURE

### Problem to be Solved by the Disclosure

However, unlike the case where this work is performed inside the factory, there are various restrictions in order to demonstrate the paint work at a place like an exhibition hall. For example, the paint should not stain the circumference of the place where the paint work is demonstrated. Moreover, a large amount of organic solvent contained in the paint should not be discharged inside the exhibition site facility. Further, in order to repeat the demonstration, the workpiece painted by the demonstration must frequently be replaced with a new non-painted workpiece. Thus, it is very difficult or substantially impossible to demonstrate the paint work at the place like the exhibition hall.

The present disclosure is made in view of the above situations, and one purpose thereof is to enable a demonstration of imitation painting in which the demonstration is easily repeatable at a place where visitors attend like an exhibition hall, without causing problems, such as staining inside the hall.

### SUMMARY OF THE DISCLOSURE

In order to solve the problem described above, an imitation paint system according to one aspect of the present disclosure includes a workpiece, a paint machine main body having a nozzle configured to discharge liquid to the workpiece, and a water feeding device configured to supply water as the liquid to the paint machine main body. At least a part or all of a surface part of the workpiece is made of material containing a color-changing substance. The color-changing substance presents a first color in a dry state and presents a second color different from the first color in a water-wet state.

According to this imitation paint system, the part of the surface of the workpiece having got wet by the water discharged from the nozzle changes in its color. Therefore, it is possible to demonstrate and present to visitors a state which looks almost the same as if a workpiece is being applied with color using paint. In addition, the circumference of the place where the demonstration is performed is not stained with paint, and an organic solvent contained in many general paints is not scattered in the surrounding atmosphere. Furthermore, even when the workpiece is once water-wet and discolored (imitation colored), its color returns to the original color (first color) by drying with air or the like, thus, the workpiece can be used again for the next demonstration. That is, replacement of the workpiece is not required.

The “color-changing substance” here is the substance showing a phenomenon and a characteristic in which optical property such as color, changes reversibly by external stimuli. Representative color-changing substance includes “chromic substance.” Although the external stimuli for color changing differ depending on respective color-changing substances, they may be heat, electricity, pressure, etc. in addition to water. The “color-changing substance” in the present disclosure is the paint changing its appeared color when the coat is in a dry state and when it is in a water-wet state.

The entire of the workpiece may be made of resin containing the color-changing substance, or only a thin layer configuring the surface of the workpiece may be made of material containing the color-changing substance. Moreover, the entire surface of the workpiece may be made of material containing the color-changing substance, or only a part of the surface of the workpiece may be made of material containing the color-changing substance.

In the imitation paint system, a part or all of a surface of a base body of the workpiece may be coated with a coat of color-changing paint. The coat of the color-changing paint may be made of material containing the color-changing substance. The coat of the color-changing paint may present the first color in the dry state, and present the second color different from the first color in the water-wet state.

According to this imitation paint system, it is possible to demonstrate and present to the visitors a state which looks almost the same as if a workpiece is being applied with color using a general paint which is not color-changing paint.

The “color-changing paint” here is the paint containing the color-changing substance. Thus, this coat shows a phenomenon and a characteristic in which optical property such as color, changes reversibly by external stimuli. The “color-changing paint” in the present disclosure is the paint changing its appeared color when the coat is in a dry state and when it is in a water-wet state.

Moreover, in the imitation paint system, the workpiece may be formed by applying the color-changing paint to the surface of the base body. Alternatively, the workpiece may be formed by pasting a film, to which the color-changing paint is applied, to the surface of the base body so that the painted surface is at the front side. Further, the first color may be non-transparent color, and the second color may be colorless and transparent.

The imitation paint system may further include a conveying device configured to displace the nozzle relatively to the workpiece by moving one or both of the paint machine main body and the workpiece.

Moreover in the imitation paint system, the conveying device may be a manipulator, and the paint machine main body may be attached to a wrist of the manipulator.

Moreover in the imitation paint system, the conveying device may be a manipulator, a workpiece holding device may be attached to a wrist of the manipulator, and the workpiece may be held by the workpiece holding device.

Moreover in the imitation paint system, the conveying device may be comprised of a first manipulator and a second manipulator, the paint machine main body may be attached to a wrist of the first manipulator, a workpiece holding device is attached to a wrist of the second manipulator, and the workpiece may be held by the workpiece holding device.

Moreover the imitation paint system may include a control device configured to control the conveying device, the control device storing an automatic operation program to cause the conveying device to operate automatically, and the conveying device operating automatically according to the automatic operation program.

Moreover the imitation paint system may include a control device configured to control the conveying device, and an operation input device configured to accept an input of operation of an operator and generate an operational instruction. The control device may receive the operational instruction from the operation input device and control operation of the conveying device so as to correspond to the operational instruction.

Moreover, the imitation paint system may further include an air ejecting device configured to blow drying air for drying the surface of the workpiece to the workpiece. Further, the drying air may be, air, or heated air generated by heating air, or dehumidified air generated by dehumidifying air.

In order to solve the problem described above, an imitation paint method according to one aspect of the present disclosure includes the steps of preparing a workpiece, at least a part or all of a surface part of the workpiece being made of material containing a color-changing substance, and discharging, from a nozzle of a paint machine main body having a nozzle configured to discharge liquid, water as the liquid to the workpiece. The color-changing substance presents a first color in a dry state, and presents a second color different from the first color in a water-wet state.

According to this imitation paint method, the part of the surface of the workpiece having got wet by the water discharged from the nozzle changes in its color. Therefore, it is possible to demonstrate and present to visitors a state which looks almost the same as if a workpiece is being applied with color using paint. In addition, the circumference of the place where the demonstration is performed is not stained with paint, and an organic solvent which is contained in many general paints is not scattered in the surrounding atmosphere. Furthermore, even when the workpiece is once water-wet and discolored (imitation colored), its color returns to the original color (first color) by drying with air or the like, thus, the workpiece can be used again for the next demonstration. That is, replacement of the workpiece is not required.

### Effect of the Present Disclosure

According to the present disclosure, it is possible to demonstrate and present to the visitors a state which looks almost the same as if a workpiece is being applied with color using a general paint, easily repeatable and without staining a place where the imitation paint is demonstrated with the paint and organic solvent.

### BRIEF DESCRIPTION OF DRAWINGS

FIG. 1 is a schematic diagram illustrating an imitation paint system which is one embodiment of the present disclosure.

FIGS. 2A to 2C are views illustrating structures of various workpieces to which imitation paint is applied.

FIG. 3 is a schematic diagram illustrating an imitation paint system which is one embodiment of the present disclosure.

FIG. 4 is a schematic diagram illustrating an imitation paint system which is one embodiment of the present disclosure.

FIG. 5 is a schematic diagram illustrating an imitation paint system which is one embodiment of the present disclosure.

FIG. 6 is a schematic diagram illustrating an imitation paint method which is one embodiment of the present disclosure.

### MODES FOR CARRYING OUT THE DISCLOSURE

Hereinafter, embodiments of the present disclosure will be described with reference to the drawings. Note that, throughout the drawings, the same characters are assigned to the same or corresponding parts to omit redundant description. Moreover, throughout the drawings, components illustrating the present disclosure are selectively illustrated, and illustration of other components may be omitted. Further, the present disclosure is not limited to the following embodiments.

### Embodiment 1

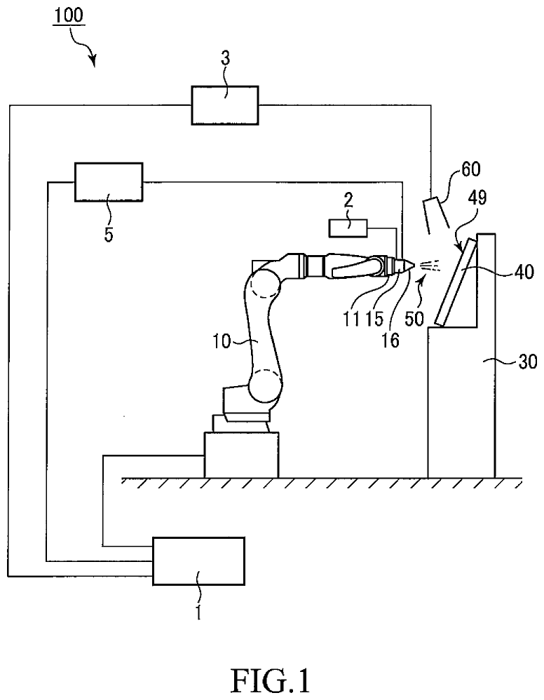

FIG. 1 is a configuration diagram of an imitation paint system 100. This imitation paint system 100 includes a paint gun 15 which is a main body of a painting device, a placing part 30 where a workpiece 40 is placed, a manipulator 10 which is a conveying device, a water feeding device 2 which supplies water 50 discharged from a nozzle 16 to the paint gun 15, and a control device (robot controller) 1 which controls operation of the manipulator 10.

The control device (robot controller) 1 is provided with a processor, performs, by the processor, decoding and calculation of various signals inputted from stored program(s), external device(s), etc., and governs a motion control of the manipulator 10, signal outputs from various output ports, etc.

The paint gun 15 is attached to a wrist 11 of the manipulator 10. The nozzle 16 constitutes a tip-end part of the paint gun 15, and the water 50 is discharged therefrom.

The paint gun 15 is controlled by a driving device 5 so that a discharge of the water from the nozzle 16 is turned ON and OFF, and an amount of discharge is also controlled. Since the driving device 5 is controlled by the control device 1, the paint gun 15 is driven and controlled by the control device 1 accordingly.

The workpiece 40 to which imitation paint is applied is placed on a placing stand 30 which is the placing part. By the manipulator 10 operating, while the nozzle 16 moves near a front surface 49 of the workpiece 40, the nozzle 16 discharges the water 50 to the entire front surface 49.

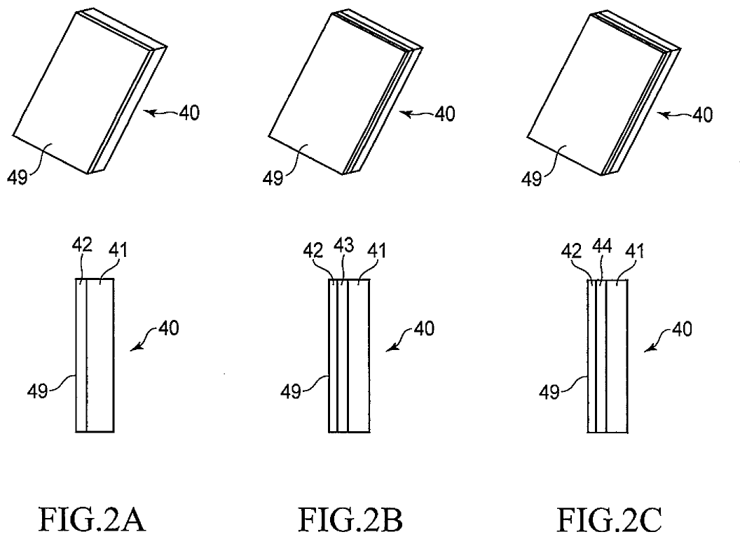

The workpiece 40 may have various configurations, as illustrated in FIGS. 2A, 2B, and 2C.

In FIGS. 2A to 2C, a perspective view of each workpiece 40 is illustrated in an upper row, and a cross-sectional view of each workpiece 40 is illustrated in a lower row. Note that, in FIGS. 2A to 2C, the thicknesses of coats 42 and 43 and a film 44 are drawn larger by being exaggerated with respect to the thickness of a base body 41.

In FIG. 2A, a configuration in which the front surface of the base body 41 made of resin is covered with the coat 42 made of color-changing paint is illustrated.

The term “color-changing paint” as used herein refers to paint which changes its appeared color when the coat 42 is in a dry state and when it is in a water-wet state. For example, the color is non-transparent white in the dry state, and is non-transparent green in the water-wet state. In another example, the color is non-transparent white in the dry state, and is colorless and transparent in the water-wet state.

Here, the kinds of color include transparent colors and non-transparent colors. Here, transparent green and non-transparent green are considered to be different colors. Moreover, colorless and transparent is included in the kind of color. Colorless and transparent and non-transparent white are considered to be different colors.

Note that, as a color-changing paint which is commercially available, the brand name “Water Chromic Cream” is known.

To supplement about the color-changing nature, it can be described as follows. That is, a phenomenon and a characteristic in which optical property such as color, changes reversibly by external stimuli is called “chromism,” and a substance which indicates chromism is called “chromic substance” or “chromic material.” Although the external stimuli which induce chromism differ depending on the chromic substance, they are heat, electricity, pressure, etc. in addition to water.

FIG. 2B illustrates a configuration in which the front surface of the base body 41 made of resin is covered with the coat 43 made of common paint which is not the color-changing paint, and the coat 43 is further covered with the coat 42 made of the color-changing paint.

FIG. 2C illustrates a configuration in which the film 44 covered with the coat 42 made of the color-changing paint is pasted onto the front surface of the base body 41 made of resin. The film 44 may be non-transparent color or may be the transparent color. Further, it may be colorless and transparent.

Thus, although various configurations may be considered as the configuration of the workpiece 40, here, one example in which the following workpiece 40 having a configuration illustrated in FIG. 2A is used is first illustrated as a more concrete example. The workpiece 40 has the base body 41 made of black resin. The color-changing paint is applied to the front surface of the base body 41 to form the coat 42. The coat 42 made of the color-changing paint presents non-transparent white as a first color in the dry state, and presents non-transparent green as a second color in the water-wet state.

An imitation paint work is demonstrated to such a workpiece 40 by the imitation paint system 100 as illustrated in FIG. 1.

In the demonstration, the control device 1 runs an automatic operation program stored therein to automatically operate the manipulator 10. That is, the operation of the manipulator 10 is performed automatically by the automatic operation program, and the demonstration is performed automatically, without the imitation paint work requiring operation by an operator.

In the initial stage of the demonstration, since the coat of the color-changing paint on the surface of the workpiece 40 is in the dry state, the workpiece 40 appears in white. When water 50 is discharged to the workpiece 40 from the nozzle 16, since the coat 42 becomes in the water-wet state, the part having got wet by the water of the surface of the workpiece 40 becomes in non-transparent green. That is, a state as if the green paint is sprayed can be presented to visitors in an imitating manner. In this way, when the entire front surface of the workpiece 40 is changed into green, one round of the imitation paint is finished.

Next, an air blower 60 illustrated in FIG. 1 is driven. The air blower 60 is installed at the location from which it can spray air onto the workpiece 40. As for the blowing air, surrounding air may be used as it is without applying any processing. Alternatively, in order to shorten a drying time of the surface of the workpiece 40, heated air may be blown after the air is heated by a heating device. Further, for shortening the drying time of the surface of the workpiece 40, dehumidified air may be blown after the air is dehumidified (dried) by a dehumidifying device.

The operation of the air blower 60 is controlled by an air blower driving device 3 to be turned ON and OFF. Since the air blower driving device 3 is controlled by the control device 1, the air blower 60 is driven and controlled by the control device 1 accordingly.

By driving the air blower 60, the coat 42 on the surface of the workpiece 40 which is in the water-wet state and presents non-transparent green returns to the dry state, thereby again presenting non-transparent white. Then, the workpiece 40 appears to be in white, and therefore, it can be used for the next imitation paint demonstration.

The following workpiece 40 having a configuration illustrated in FIG. 2B which is another configuration may also be used. That is, the workpiece 40 has the base body 41 made of black resin. The common green paint (paint which is not a color-changing paint) is applied to the front surface of the base body 41 and the coat 43 is covered thereon. The color-changing paint is further applied to the green coat 43 to form the coat 42. The coat 42 of the color-changing paint presents non-transparent white as the first color in the dry state, and presents colorless and transparent as the second color in the water-wet state.

When this workpiece 40 is used, the workpiece 40 appears to be in white in the initial stage of the demonstration, but when the water is discharged to the workpiece 40, since the coat 42 becomes in the water-wet state, it becomes colorless and transparent, and therefore, the green which is the color of the coat 43 of the common paint directly applied to the base body 41 which is the undercoat appears. Thus, the imitation paint work as if green paint is applied to the white workpiece 40 can be demonstrated.

The following workpiece 40 having a configuration illustrated in FIG. 2C which is still another configuration may also be used. That is, the workpiece 40 has the base body 41 made of black resin. The film 44 to which the color-changing paint is applied is pasted on the front surface of the base body 41. The color of the material of the film 44 is non-transparent green, and the coat 42 of the color-changing paint presents non-transparent white as the first color in the dry state, and presents colorless and transparent as the second color in the water-wet state. Even if this workpiece 40 is used, the imitation paint work to which the green paint is applied to the white workpiece 40 can be demonstrated.

### Embodiment 2

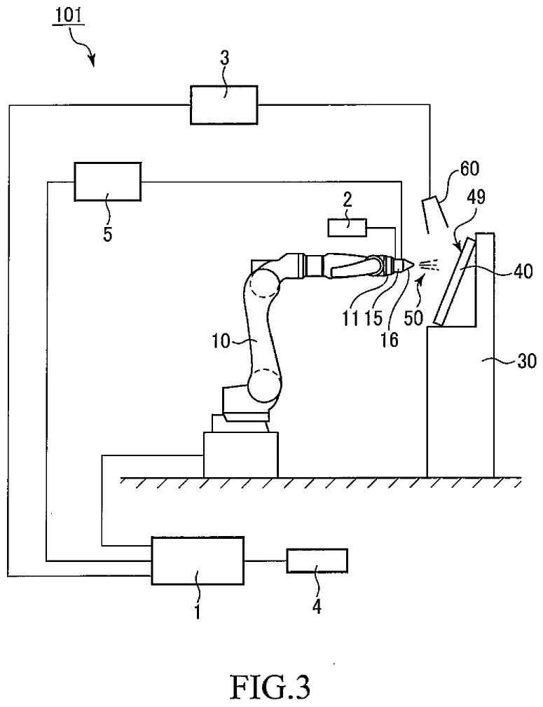

During the demonstration described above, the control device 1 runs the automatic operation program stored therein, and causes the manipulator 10 to automatically operate, without requiring the operation of the operator. However, as illustrated in FIG. 3, an imitation paint system 101 may be provided with an operation input device 4 which accepts the operation of the operator. In the imitation paint system 101 of FIG. 3, the operation input device 4 accepts an input of the operation of the operator and generates an operational instruction. The control device 1 receives the operational instruction from the operation input device 4 and controls operation of the manipulator 10 so as to correspond to the operational instruction. That is, the control device 1 controls the operation of the manipulator 10 according to the operation of the operator each time the operation occurs, without according to the automatic operation program.

### Embodiment 3

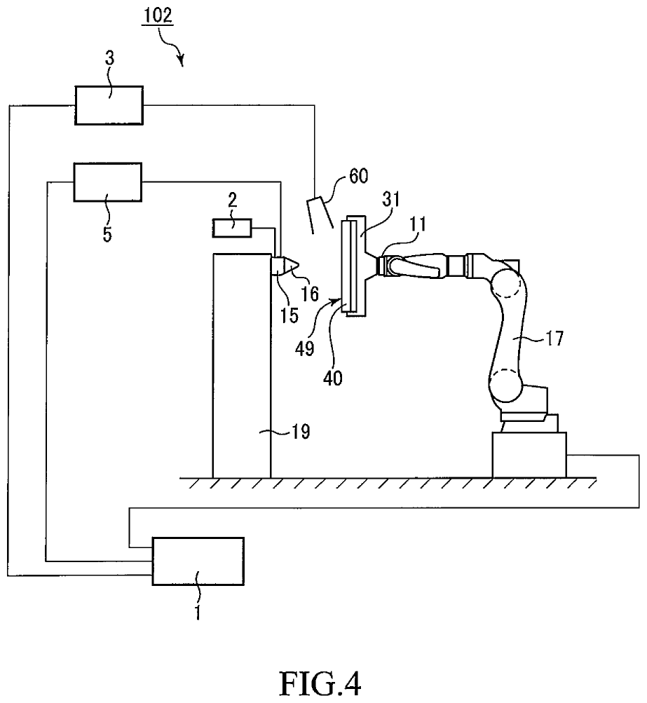

In FIG. 1, the system in which the paint gun 15 is moved with respect to the workpiece 40 by the manipulator 10 which is the conveying device is illustrated. However, as illustrated in FIG. 4, an imitation paint system 102 in which the workpiece 40 is moved by the manipulator may be constructed. That is, a clamp-type workpiece gripping device 31 is attached to the wrist 11 of a manipulator 17, and the workpiece 40 is gripped by the workpiece gripping device 31. Then, the workpiece 40 may be moved with respect to the paint gun 15 fixed at a given location of a fixed stand 19. Also by such a configuration, the nozzle 16 can be moved relatively to the workpiece 40.

### Embodiment 4

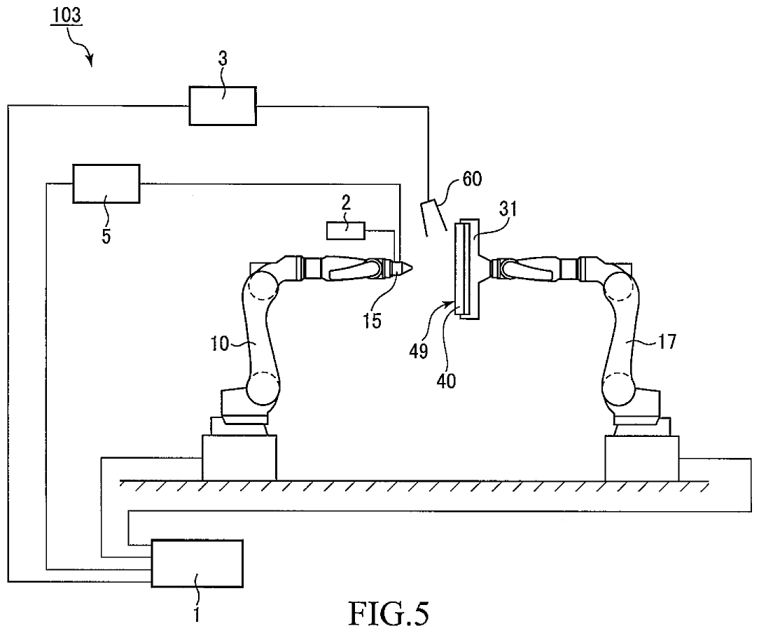

Further, as illustrated in FIG. 5, an imitation paint system 103 in which two manipulators 10 and 17 are used, the paint gun 15 is moved by the first manipulator 10, and the workpiece gripping device 31 which grips the workpiece 40 is moved by the second manipulator 17 may be constructed.

### Embodiment 5

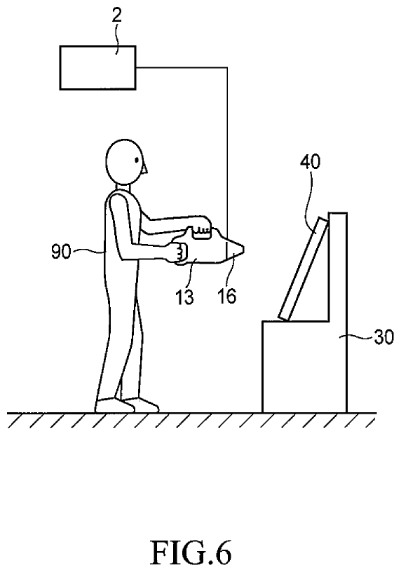

As described above, although the demonstrations using the imitation paint systems 100, 101, 102, and 103 provided with the manipulator which is the conveying device as illustrated in FIGS. 1, 3, 4, and 5 are described, it is not always necessary to use the conveying device like the manipulator for demonstrating the imitation paint work. For example, as illustrated in FIG. 6, the imitation paint work can be demonstrated, even when the operator 90 carries a portable paint gun 13 in hand and moves it, while discharging water from the paint gun 13 to the workpiece 40.

It is apparent for a person skilled in the art that many improvements and other embodiments of the present disclosure are possible from the above description. Therefore, the above description is to be interpreted only as illustration, and it is provided in order to teach a person skilled in the art the best mode that implements the present disclosure. The details of the structures and/or the functions may be changed substantially, without departing from the spirit of the present disclosure.

### INDUSTRIAL APPLICABILITY

The imitation paint system and the imitation paint method of the present disclosure are useful in the technical field of the demonstration of the painting process.

### DESCRIPTION OF REFERENCE CHARACTERS

1 Control Device
2 Water Feeding Device
3 Air Blower Driving Device
4 Operation Input Device
5 Driving Device
10 Manipulator
11 Wrist
13 Paint Gun
15 Paint Gun
16 Nozzle
17 Manipulator
30 Placing Stand
31 Workpiece Gripping Device
40 Workpiece
41 Base Body
42 Coat
43 Coat
44 Film
49 Front Surface
50 Water
60 Air Blower
90 Worker
100 Imitation Paint System
101 Imitation Paint System
102 Imitation Paint System
103 Imitation Paint System

1. An imitation paint system, comprising:
a workpiece;
a paint machine main body having a nozzle configured to discharge liquid to the workpiece; and
a water feeding device configured to supply water as the liquid to the paint machine main body,
wherein at least a part or all of a surface part of the workpiece is made of material containing a color-changing substance, and
wherein the color-changing substance presents a first color in a dry state and presents a second color different from the first color in a water-wet state.

2. The imitation paint system of claim 1, wherein a part or all of a surface of a base body of the workpiece is coated with a coat of color-changing paint,
wherein the coat of the color-changing paint is made of material containing the color-changing substance, and
wherein the coat of the color-changing paint presents the first color in the dry state, and presents the second color different from the first color in the water-wet state.

3. The imitation paint system of claim 2, wherein the workpiece is formed by applying the color-changing paint to the surface of the base body.

4. The imitation paint system of claim 2, wherein the workpiece is formed by pasting a film, to which the color-changing paint is applied, to the surface of the base body so that the painted surface is at the front side.

5. The imitation paint system of claim 2, wherein the first color is non-transparent color, and the second color is colorless and transparent.

6. The imitation paint system of claim 1, further comprising a conveying device configured to displace the nozzle relatively to the workpiece by moving one or both of the paint machine main body and the workpiece.

7. The imitation paint system of claim 6, wherein the conveying device is a manipulator, and the paint machine main body is attached to a wrist of the manipulator.

8. The imitation paint system of claim 6, wherein the conveying device is a manipulator, a workpiece holding device is attached to a wrist of the manipulator, and the workpiece is held by the workpiece holding device.

9. The imitation paint system of claim 6, wherein the conveying device is comprised of a first manipulator and a second manipulator, the paint machine main body is attached to a wrist of the first manipulator, a workpiece holding device is attached to a wrist of the second manipulator, and the workpiece is held by the workpiece holding device.

10. The imitation paint system of claim 6, comprising a control device configured to control the conveying device, the control device storing an automatic operation program to cause the conveying device to operate automatically, and the conveying device operating automatically according to the automatic operation program.

11. The imitation paint system of claim 6, comprising:
a control device configured to control the conveying device; and
an operation input device configured to accept an input of operation of an operator and generate an operational instruction,
wherein the control device receives the operational instruction from the operation input device and controls operation of the conveying device so as to correspond to the operational instruction.

12. The imitation paint system of claim 1, further comprising an air ejecting device configured to blow drying air for drying the surface of the workpiece to the workpiece.

13. The imitation paint system of claim 12, wherein the drying air is heated air generated by heating air.

14. The imitation paint system of claim 12, wherein the drying air is dehumidified air generated by dehumidifying air.

15. An imitation paint method, comprising the steps of:
preparing a workpiece, at least a part or all of a surface part of the workpiece being made of material containing a color-changing substance; and
discharging, from a nozzle of a paint machine main body having a nozzle configured to discharge liquid, water as the liquid to the workpiece,
wherein the color-changing substance presents a first color in a dry state, and presents a second color different from the first color in a water-wet state.
